(19) United States
(12) Patent Application Publication
(10) Pub. No.: US 2011/0032473 A1
(43) Pub. Date: Feb. 10, 2011

(54) STABLE-POSITION SPECTACLE HINGE

(75) Inventor: Guido Medana, Valdobbiadene (Treviso) (IT)

Correspondence Address: YOUNG & THOMPSON, 209 Madison Street, Suite 500, Alexandria, VA, 22314, US

(73) Assignee: COMOTEC S.A., Morez Cedex (FR)

(21) Appl. No.: 12/936,280

(22) PCT Filed: Apr. 3, 2009
(86) PCT No.: PCT/IB09/51417

§ 371 Date: Oct. 4, 2010

(30) Foreign Application Priority Data
Apr. 4, 2008 (IT) MI2008A000586

(51) Int. Cl. G02C 5/22

(52) U.S. Cl. 351/153

(57) ABSTRACT

A spectacle hinge is disclosed of the type including a male component and a female component, mutually coupled according to a hinge axis, as well as an elastic element fastened to the female component and elastically compressed against an eyelet of the male component, the eyelet having abutting sectors parallel to the hinge axis against which the elastic element is intended to arrange itself elastically.

### FIELD OF THE INVENTION

The present invention refers to a spectacle hinge, in particular a hinge which can take on stable positions.

### BACKGROUND ART

As known, the need exists in the spectacle field to articulate the two temple bars of a pair of spectacles to the front frame where the lenses are engaged. In this sector, two main ways exist to achieve this articulation.

On the one hand “traditional” hinges exist, i.e. simply consisting of head components between which an articulation pin is inserted, normally in the shape of a screw, which allows the simple rotation of the temple bar between two end-stop positions, corresponding to an open position and to a closed position, respectively.

On the other hand, so-called flexible hinges exist, which comprise elastic elements which also allow an over-opening position of the temple bars. This type of hinge, which has become largely widespread in the industry, offers the user greater comfort because it allows to spread apart the temple bar beyond the normal opening, allowing better wearability and a better fit to the face.

Flexible hinges including an elastic element were furthermore highly suited to evolve to a version also having a “double-snap” retaining function. In substance, flexible hinges have been suggested wherein the elastic element also acts as an elastic abutment means for a hinge component: thereby the passage between two different orientations of the temple bars is obtained only by overcoming the reaction of the elastic means. This allows to define at least two different stable positions of the hinge, typically the open position (temple bar at about 90° to the frontpiece, for spectacles in use) and the closed position (temple bar resting against the frontpiece).

Examples of these hinges may be traced in FR 2787 891 and FR 2 486 252.

This type of hinge construction, also called bistable, has an undisputed advantage, because it substantially removes the plays which tend to arise with hinge wear. As a matter of fact, with use, the coupling between the hinge components tends to loosen (for example because the pivoting screw unfastens slightly) with a resulting reduction of the friction existing between the various components. This fact normally implies the annoying drawback of the temple bars no longer being able to maintain their open or closed position, but tending to oscillate freely about the joint. The provision of an elastic element ensuring a bistable operation manages to effectively compensate for this drawback.

However, also due to how they have traditionally been conceived, prior-art bistable hinges are rather bulky, complex to manufacture and they aesthetically impact the spectacles frame. In particular, according to the prior art, the configuration of bistable hinges is closely dependent on the shape of the frame and of the temple bars.

Moreover, in sports spectacles or sunglasses, a complex flex hinge is not taken into consideration, because it reduces the stability of the spectacles, which must instead fit the user firmly.

### SUMMARY OF THE INVENTION

The object of the present invention is hence to solve the above mentioned drawbacks, providing a stable-position hinge which has a configuration being simple, inexpensive and independent with respect to the shape and the aesthetic appearance of the frame.

Such object is achieved through a device as described in its essential features in the enclosed main claim.

In particular, according to an aspect of the invention, a spectacle hinge is provided, comprising a male component and a female component, mutually coupled and hinged according to a hinge axis, the male component comprising a prismatic eyelet wherein an elastic element is further provided fastened to said female component and elastically compressed against said eyelet of the male component, said eyelet having abutting sectors parallel to said hinge axis against which said elastic element is intended to elastically abut.

According to a further aspect, the elastic element has a retaining end which can be coupled with the female component and a resting end intended to elastically abut against the abutting sectors of the eyelet.

According to another preferred aspect, the elastic element is in the shape of a reed blocked in an opening obtained in the female body of the hinge. In particular, the reed has a part bent into an S-shape which defines two bend areas intended to come into contact with two opposite abutting edges in the through-opening.

Other inventive aspects of the hinge are described in the dependent claims.

### BRIEF DESCRIPTION OF THE DRAWINGS

Further features and advantages of the device according to the invention will in any case become more evident from the following detailed description of some preferred embodiments, given by way of example and shown in the accompanying drawings, wherein:

FIG. 1 is a perspective view of a hinge according to a first embodiment of the invention in an open condition;

FIG. 2 is a view similar to that of FIG. 1 with the hinge in a closed condition;

FIG. 3 is a perspective, exploded view of the hinge of FIG. 1;

FIG. 4 is a perspective view of the male component of the hinge of FIG. 1;

FIG. 5 is a perspective view of the elastic element of the hinge of FIG. 1;

FIG. 6 is a perspective view of the female component of the hinge of FIG. 1;

FIG. 7 is a section view of the female component of FIG. 6;

FIGS. 8-10 are section views of the hinge of FIG. 1 in a closed, intermediate and open position, respectively;

FIG. 11 is a perspective view of a female component with the elastic element according to a second embodiment of the invention;

FIG. 12 is an exploded, perspective view of a female component with the elastic element according to a third embodiment of the invention;

FIG. 13 is an exploded, perspective view of a female component with the elastic element according to a fourth embodiment of the invention; and

FIGS. 14 and 15 are exploded, perspective views of a female component with the elastic element according to a fifth embodiment of the invention.

### DETAILED DESCRIPTION OF PREFERRED EMBODIMENTS

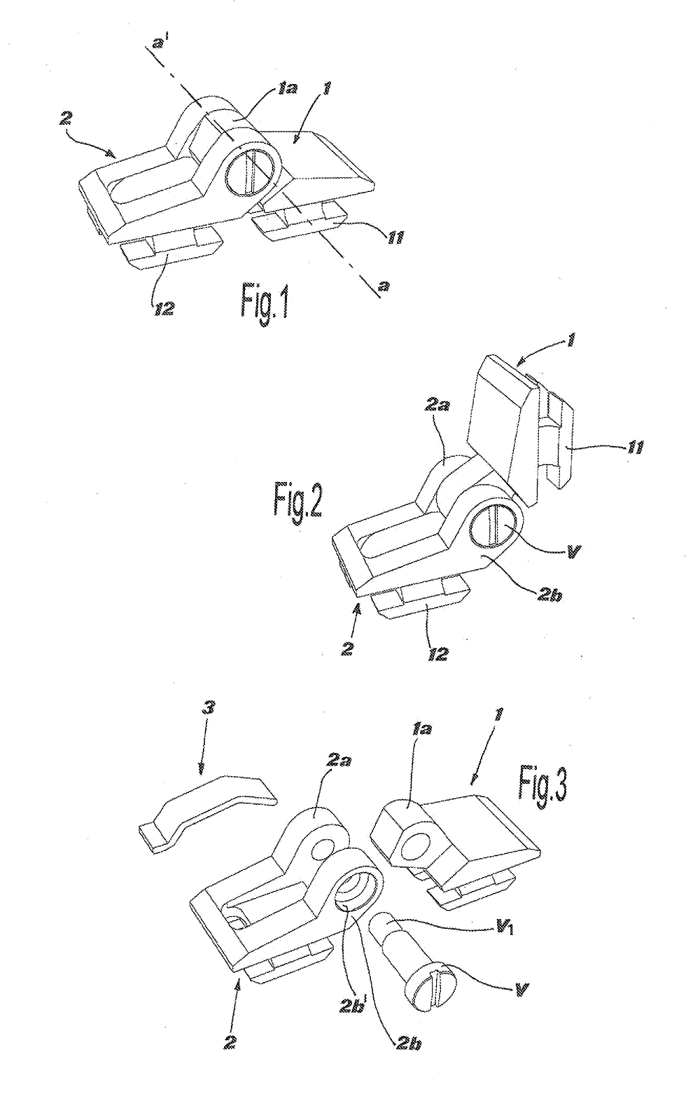

As clearly visible in FIGS. 1-3, a spectacle hinge consists, in a manner known per se, of a male component 1 and of a female component 2 which are apt to rotatingly couple with each other around a hinge axis a-a′. In particular, the female component has two wings or flanges 2a and 2b between which a portion of prismatic (typically cylindrical) eyelet 1a of the male component is intended to insert.

Typically, the hinge axis is represented by a screw or pin V, with a threaded end V₁ which is screwed into one of the two end wings of the female component. In such case, the other wing of the female component has a countersink 2b′ apt to house the head of screw V.

In the drawings, male component 1 and female component 2 are shown in a configuration which provides anchoring feet 11 and 12, by which the hinge can be fastened to the frontpiece and to the temple bars of the spectacles (not shown). In the example shown, which is not to be intended in a limiting sense, anchoring feet 11 and 12 are made of a metal material, like the rest of the hinge, and are intended to be embedded in the plastic material of which the frontpiece and the temple bars of the spectacles (for example a classic pair of sunglasses obtained by injection moulding) are made of.

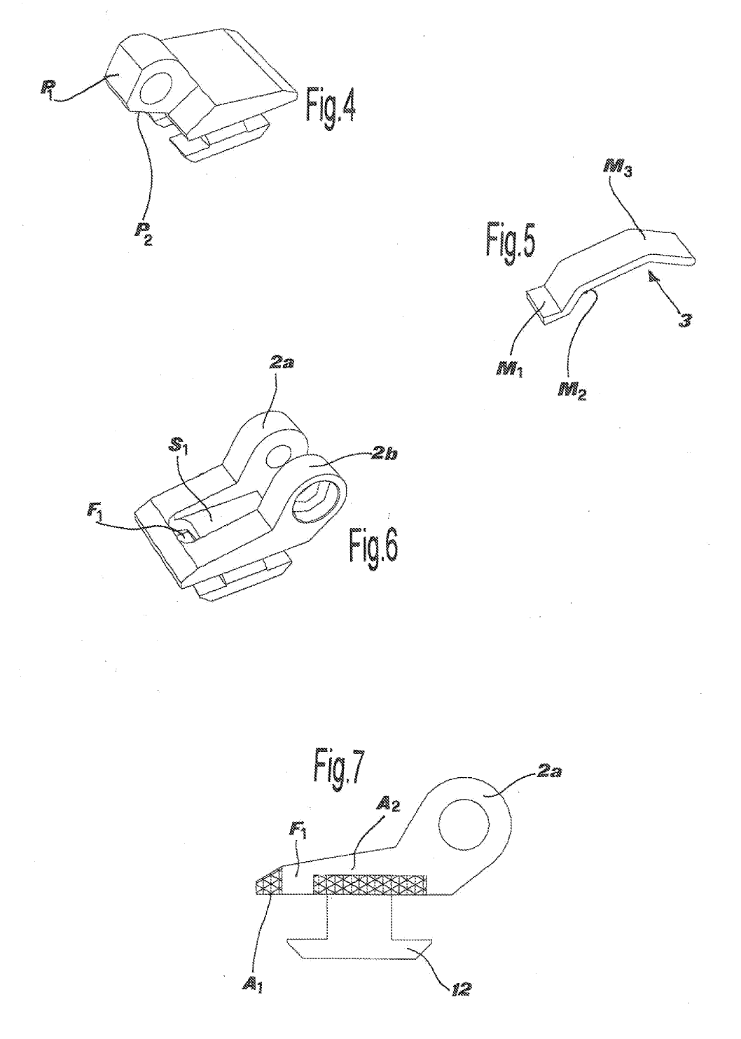

According to a more preferred embodiment of the invention (FIGS. 1-10), the cylindrical eyelet 1a has, on its side surface, between the two wings 2a and 2b, at least a pair of planar sectors P₁ and P₂ parallel to the axis of rotation a-a′; moreover, between the two wings 2a and 2b of female component 2, an elastic element 3 is housed, arranged partly between the base of the female component and the cylindrical eyelet 1a of the male component.

In particular, elastic element 3—also definable as a shape-retaining element—has one end fastened to the female body and one abutment portion M₃ intended to remain bearing against planar sectors P₁ and P₂.

According to the preferred embodiment of FIGS. 1-10, elastic element 3 is in the shape of an elastic metal reed which is simply blocked, at one end, on the body of the female component provided with a suitable window F₁. In such case, reed 3 has a generically S-shaped retaining part, with a flap and a bearing bend, M₁ and M₂, respectively. The width of reed 3 is such as to be able to be housed in the inner bulk between the two wings 2a and 2b.

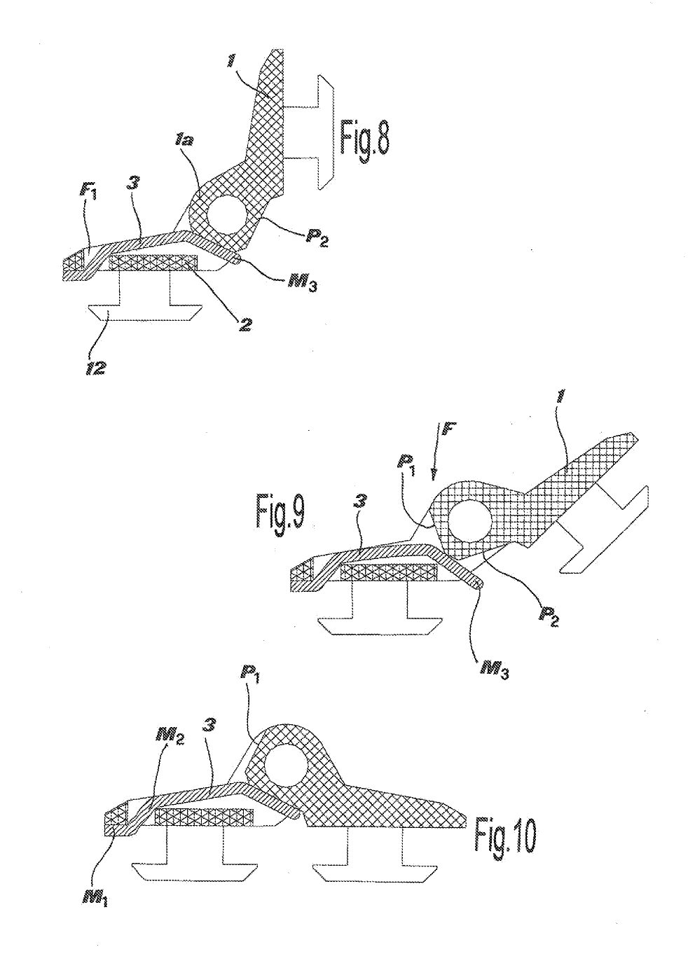

As visible in FIGS. 8-10, in the assembled condition of the hinge, reed 3 is inserted in window F₁, with bearing flap M₁ and bend M₂ resting against the opposite edges A₁ and A₂ of window F₁.

Due to its wide-S shape, the remaining portion of reed 3 extends between the two wings 2a and 2b, with the other resting end M₃ inserted between female body 2 and the eyelet 1a of the male component, elastically bearing (hence in a slightly preloaded condition) on said male component, as clearly shown in FIG. 8.

In this position, reed 3 is kept slightly bent towards female body 2 by the contact with male eyelet 1a. Bearing end M₃ remains resting against the planar sector P₁ and hence tends to prevent a free rotation of male component 1 with respect to female component 2.

This is a stable equilibrium position due to the fact that the planar sectors P₁ and P₂ are at a radial distance from the lower axis of rotation with respect to the remaining surface portion of eyelet 1a. As a matter of fact, during the mutual rotation of the two components 1 and 2, due to the existence of the two planes P₁ and P₂, the bulk radius of eyelet 1a increases with respect to the axis of rotation. Therefore elastic reed 3 is further pushed, by the surface of the eyelet which runs above it, to the body of the female component (see arrow F in FIG. 9), bending and at the same time developing an elastic bias which opposes such deformation: in order to obtain the rotation of the eyelet with respect to the female body, an elastic reaction of reed 3 must hence be overcome.

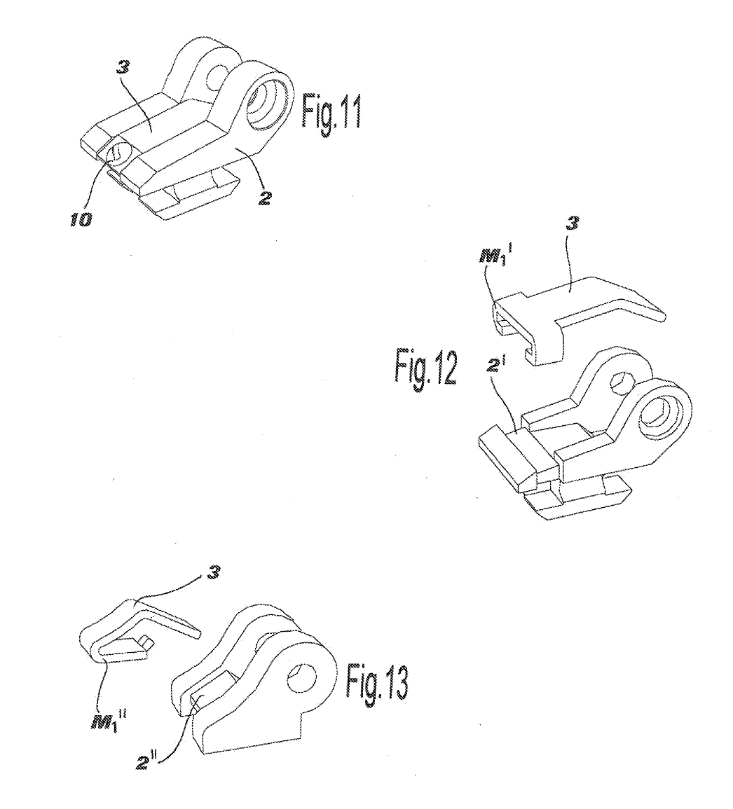

Once the rotation has been completed and the open position of FIG. 10 has been achieved, the bearing end M₃ of reed 3 goes again in abutment against the second planar sector P₂, thereby determining a second condition of stable equilibrium.

As can be guessed, due to this simple construction, the hinge can be rotated between two states of fixed equilibrium—corresponding to a closed condition (FIG. 8) and to an open condition (FIG. 10) of the temple bars with respect to the spectacle frontpiece—passing through an unstable condition (FIG. 9) which can be achieved only by overcoming the reaction of an elastic element 3.

Thereby a bistable hinge is obtained, which ensures pleasant operation (when opening and closing the temple bars) even when a loosening of hinge-tightening screw V occurs. The structure is extremely simple (it consists of three elements only) and hence also inexpensive. Since the elastic element is housed between the two hinge components, the hinge according to the invention is also self-contained—in the sense that it does not depend on the specific shape of the spectacle frontpiece and temple bars—and applicable to any pair of spectacles and hence does not have any relevant aesthetic impact. It may hence be advantageously used also on sunglasses or sports glasses, whereon flexible hinges are not welcome.

Also, should the elastic element break or become accidentally detached, hinge operation would not be impaired, because it can still operate as a conventional hinge.

In FIGS. 11-15, alternative embodiments for the fastening system of reed 3 to the body of female component 2 are shown.

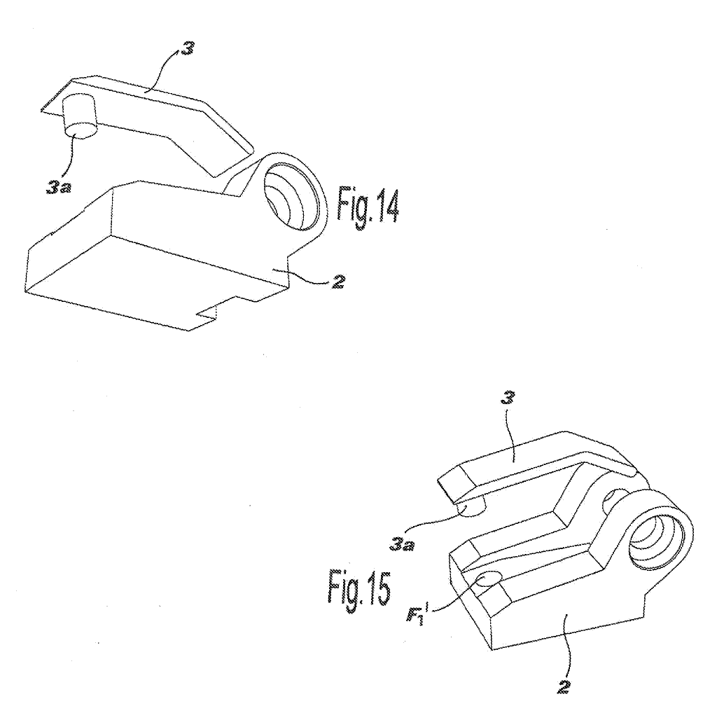

In FIG. 11 the retaining part or end of elastic reed 3 is fastened to female body 2 by means of a screw or a rivet 10. In FIG. 12, retaining end M₁′ is C-shaped so that it can be snap-closed (clipwise) around a suitable seat 2′ of female component 2. Seat 2′ is preferably shaped as a groove parallel to the axis of rotation of the hinge. In FIG. 13 another shape of reed 3 is provided, which also has a curved retaining end M₁″ to be snap-fastened to a corresponding portion 2″ of female component 2. Again, in FIGS. 14 and 15, an embodiment is shown wherein the retaining end of reed 3 has a small pin 3a apt to forcedly engage with a corresponding hole F₁′ in female component 2. Pin 3a is configured to enter hole F₁′ in a substantially orthogonal direction to the flexible reed.

However, it is understood that the invention is not limited to the specific embodiments illustrated above, which make up only non-limiting examples of the scope of the invention, but that a number of variants are possible, all within the reach of a person skilled in the field, without departing from the scope of the invention.

For example, if one would like more than two stable positions of the hinge, more than two planar sectors can be provided on male eyelet 1a.

Again, although reference has always been made to planar sectors P₁ and P₂, it is not ruled out that the same operation may be ensured by different-shape sectors (for example with V-recesses), which can hence be more suitably defined “abutting sectors”. The end of the elastic element intended to cooperate with such abutting sectors will be shaped accordingly to better engage with/disengage from the same, even though to the partial detriment of manufacturing economy.

1) Spectacle hinge of the type comprising a male component (1) and a female component (2) mutually coupled and hinged according to a hinge axis (a-a′), the male component comprising a prismatic eyelet (1a), characterised in that it further comprises an elastic element (3) fastened to said female component (2) and elastically arranged against said eyelet (1a) of the male component, said eyelet (1a) having abutting sectors (P₁, P₂) parallel to said hinge axis (a-a′) against which said elastic element (3) is intended to elastically abut itself.

2) Spectacle hinge as claimed in claim 1, wherein said elastic element (3) has a retaining end (M₁) which can be coupled with said female component (2) and a bearing end (M₃) intended to abut itself elastically against said abutting sectors (P₁, P₂).

3) Hinge as claimed in claim 2, wherein said elastic element (3) is shaped as a reed mounted cantilevered on said female component (2).

4) Hinge as claimed in claim 3, wherein said reed is blocked in an opening (F₁,F₁′) obtained in said female body (2).

5) Hinge as claimed in claim 4, wherein said reed (3) has a part bent into an S-shape which defines two bend areas (M₁, M₂) intended to come into contact with two opposite resting edges (A₁, A₂) of said through-opening (F₁).

6) Hinge as claimed in claim 4, wherein said reed (3) has a small pin (3a) engageable into a hole (F₁′) drilled in said female component (2).

7) Hinge as claimed in claim 3, wherein said reed (3) is fastened to said female component by means of a screw or rivet (10).

8) Hinge as claimed in claim 3, wherein said reed (3) has a curved portion (M₁′, M₁″) intended to snap-fasten onto the female component (2).

9) Hinge as claimed in claim 1, wherein said abutting sectors (P₁, P₂) are planar surfaces.

10) Hinge as claimed in claim 1, wherein said male component (1) and female component (2) are made of metal and have each an anchoring foot (11, 12) apt to be embedded in the material making up the temple bars and/or the spectacle frontpiece.
